(19) United States
(12) Patent Application Publication
(10) Pub. No.: US 2004/0226342 A1
(43) Pub. Date: Nov. 18, 2004

(54) Cargo detection apparatus

(76) Inventor: Todd Taricco, Zephyr Cove, NV (US)

Correspondence Address: IRELL & MANELLA LLP, 840 NEWPORT CENTER DRIVE, SUITE 400, NEWPORT BEACH, CA, 92660, US

(21) Appl. No.: 10/798,530

(22) Filed: Mar. 10, 2004

Related U.S. Application Data
(60) Provisional application No. 60/453,633, filed on Mar. 10, 2003.

(51) Int. Cl. G01N 23/04

(52) U.S. Cl. 73/23.35

(57) ABSTRACT

Method and apparatus for inspection of cargo transported in containerized shipping Containers. In accordance with the method the container is in fact used as a pressure Vessel to allow the infiltration of gasses into the contents of the container. The gasses are then extracted from the container to be examined by the attached devices. The inspection of the contents also includes radiological materials. The process may be accomplished in a ground based environment or while suspended on the container handling equipment.

### REFERENCE TO CROSS-RELATED APPLICATION

This application claims priority to U.S. Provisional application No. 60/453,633, filed on Mar. 10, 2003.

### FIELD OF THE INVENTION

The subject mater disclosed generally relates to the examination of cargo for dangerous materials, radiological materials, contraband and weapons. In addition there are several methods to assure the identity of the cargo.

### BACKGROUND INFORMATION

There have been a number of procedures and methods for analyzing the chemical composition of cargo. For example, U.S. Pat. No. 5,274,356 issued to Todd Taricco discloses the use of pressure to analyze the contents of air cargo for explosive devices and contraband.

### PRIOR ART

A need has been identified to examine the contents of shipping containers be it oceangoing, trucks or any relativity sealed packages. U.S. Pat. No. 5,274,356 issued to Todd Taricco discloses the first attempt to utilize pressure variance to extract gas-laden information from the contents of sample cargo. This technology is in current in use by an airline to inspect cargo and baggage.

### BRIEF SUMMARY OF THE INVENTION

Method and apparatus is intended to utilize the actual shipping container as the pressure vessel to infiltrate the contents with gasses or suspensions to allow the extraction of these materials for analysis. There are several methods to do this analysis including gas chromatography, diffraction, photo luminescence, and many other commercially available tools. The interface between the sampling device and the container requires features that are described herein. The inspection of these shipping units be them trucks or ocean containers is a paramount concern to all countries. Determining the chemical and radiological composition of freight for the presence of contraband, explosives, biological agents or nuclear materials.

### BRIEF SUMMARY OF THE DRAWINGS

FIG. 1 is a visual of the implementation of the system mounted on a container crane.

FIG. 2 is the insertion probe

FIG. 3

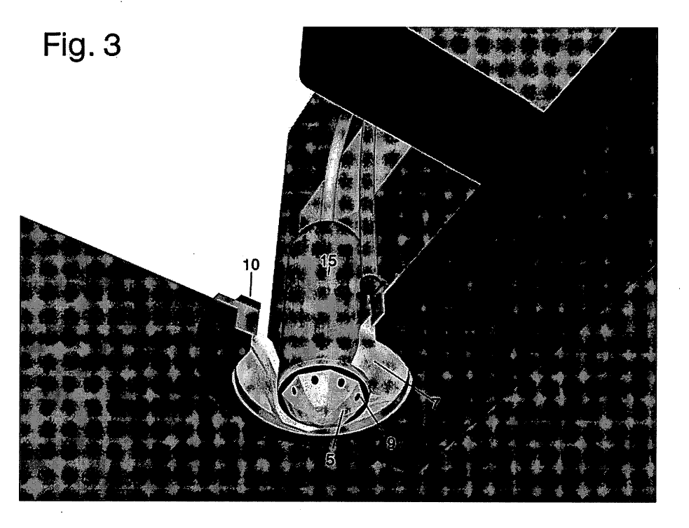

### DETAILED DESCRIPTION OF THE INVENTION

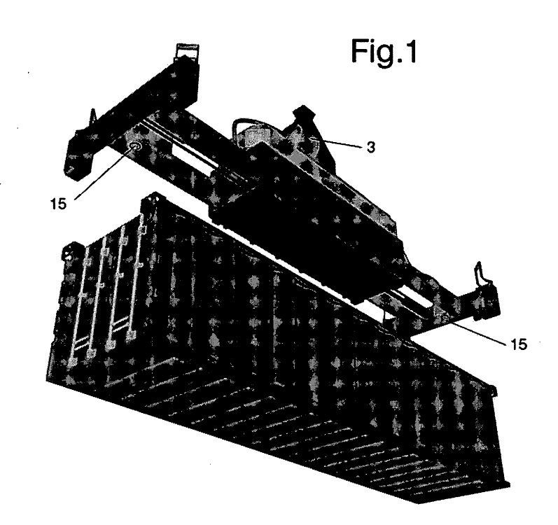

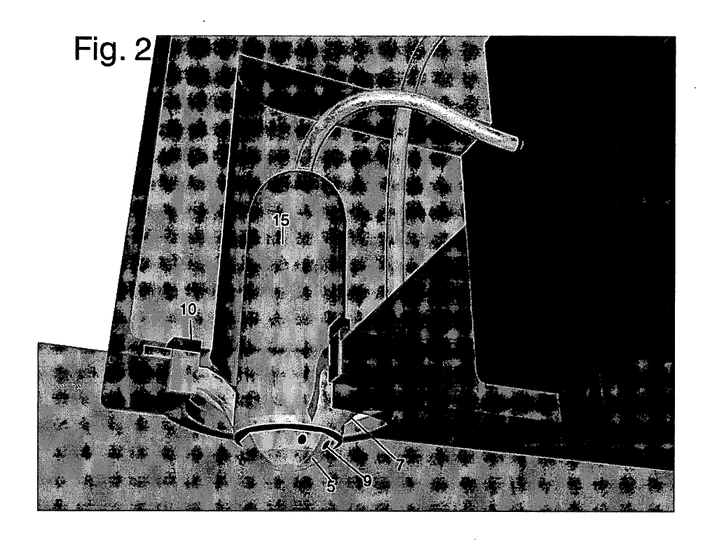

First referring to FIG. 1 the system utilizes a method and apparatus to gain access to the environment within the container. FIG. 1 item 15 This apparatus is shown mounted on a container crane. The apparatus is comprised of method of gaining access to the container FIGS. 1 & 2 item 15, a method of pressurizing the container FIG. 1 item 3, and extracting a sample from the container FIG. 1 item 3. In addition the insertion probe is fitted with the ability to detect radiation within the container FIG. 2 item 5. Radiation detectors are fitted to the tip of the probe and can provide gross location of neutron or gamma sources located within the container. The insertion seals comprised of an external mating ring and a elastomeric FIGS. 2 & 3 item 7 folded seal that is convex. This prevents water and contaminants from collecting on the surface of the seal. The outer seal ring is also fitted with a mechanical key FIG. 2 item 10 that by the use of indentations provides for the identification of the container. The insertion probe separates the seal and gains access to the container environment.

When a container is suspended on the crane it is indexed to an exact position, the identity of the container is known by the use of the identification key (disclosed herein) and adequate time is available for all testing without slowing port operations. The use of pressure swing adsorption allows very accurate analysis of the contents chromatography The system sampling equipment can be mounted on the crane frame and does not pose any technological hurdles.

Several suppliers can supply a continuous operation, sensitive, and selective device for detecting explosives in containers. The system utilizes differential mobility spectrometer (DMS) device uses RF-driven, miniature cell, which is different from most of the conventional time-of-flight based ion mobility spectrometer (IMS) devices. The main advantage of the device is that 100% of the ions generated in the source entered the cell, thus providing much higher sensitivity compared to time-of-flight devices commonly employed for explosive and chemical warfare agent detection, which only use approximately 1% of the ions generated in the ion source. For container explosive detection application, in addition to detecting low-level explosives, the low false-positive alarm rate is of premium importance. The DMS has a superior sensitivity compared to other competing devices, which makes the detection of low-level explosive possible. With a sorbent trap and gas chromatograph (GC) front end for rejecting other atmospheric contaminants, the false-alarm rates will be greatly reduced. The proven arrangement of the sorbent trap/GC. The systems are linked to a central monitoring station to alert the proper authorities in the event of a positive reading.

While the preferred embodiment of the apparatus and method of the invention have been disclosed and described herein, it is understood by those skilled in the art that various changes in form and detail may be made therein without departing from the scope and spirit thereof.

I claim:

1. A method of pressurizing and depressurizing a shipping container containing the following steps:
a. Inserting or matting to a soft elastomeric seal mounted on the container.
b. Pressurizing and depressurizing the container to a level under 1 psi positive and negative pressure.
c. Extracting the gases and delivering a gas sample to a chromatographic analyzer to determine the chemical composition to determine the presence of contraband, explosives or biological agents.

2. A method of inserting a radiological probe through a soft seal mounted on the container.

3. The method of claim 1 simultaneously performing the method of claim 2.

4. A apparatus forming a penitratable soft seal design that the perimeter has mechanical indentations that can be read by the matting device to identify the unique serial number of the soft seal.

5. The mounting of the apparatus described in claim 1 on the spreader of a shipping container crane.

6. The mounting of the apparatus described in claim 2 on the spreader of a shipping container crane.

7. The mounting of the apparatus described in claim 3 on the spreader of a shipping container crane.
